(19) United States
(12) Patent Application Publication
(10) Pub. No.: US 2003/0191949 A1
(43) Pub. Date: Oct. 9, 2003

(54) Authentication system, authentication request device, validating device and service medium

(76) Inventor: Akihiro Odagawa, Nara (JP)

Correspondence Address: MCDERMOTT WILL & EMERY, 600 13TH STREET, N.W., WASHINGTON, DC, 20005-3096, US

(21) Appl. No.: 10/362,871

(22) PCT Filed: Aug. 30, 2001
(86) PCT No.: PCT/JP01/07503

(30) Foreign Application Priority Data
Aug. 30, 2000 (JP) 2000-260390

(51) Int. Cl. H04L 9/00

(52) U.S. Cl. 713/186

(57) ABSTRACT

An authentication requester 11 uses property 13 thereof to request authentication. When an encryption key 41 for requesting authentication is input into the property 13, the encryption key 41 and a public key 42 (public information for encryption) are combined, such that encrypted information 46 is computed from biometrics information 44 and variable information 45 on varying location, time, etc. The encrypted information 46 is then transmitted as presented information 14 to a verification unit 16A. In the verification unit 16A, an encryption key 43 for authentication and the public key 42 (public information for decryption) are used to decode the encrypted information 46, and the decoded information is compared for a match. When a configuration in which the encryption key 41 merely passes through the property 13 and the verification unit 16A and does not remain as a default value, is adopted, the risk of theft of the encryption key 41 by a third party is reduced.

### TECHNICAL FIELD

The present invention relates to authentication systems which can be used for receipt of offered services or commodity products, and to authentication request devices, verification devices and service media for the authentication systems.

### BACKGROUND ART

For a person to receive an offered service or commodity product, authentication is conventionally performed to determine whether the person who requests to receive the service or commodity product is the rightful person or not to receive what is being offered. The following describes specific examples in which authentication is utilized.

Authentication

In a typical example of authentication, assume a depositing system at a bank. In this case, a user requests the bank to open an account for him/her. The opening of the account corresponds to a registration in the bank. At the time the account is opened, the user also registers what will be used as evidence for authentication. A so-called registered seal impression is used as the evidence. A personal identification number used for making deposits and withdrawals in an automatic telling machine has essentially the same effect as the registered seal impression. Specifically, it is necessary to verify whether the person who requests a cash withdrawal from the bank account is the registered person or not in order that the requested cash withdrawal be made from the registered person's account without error. For this purpose, a registered seal impression or a personal identification number is used.

Authentication for the Case of a Credit Card

Suppose that a credit card is used for shopping. In this case, a buyer needs to present to the storekeeper, as evidence showing that the buyer is a member of a card system that the store participates in, his/her card that each card member of the card system carries. The procedure for becoming a member in the card system corresponds to a pre-registration. In this sense, the authentication using credit cards is authentication according to the personal possession “card,” while separate cardholder authentication is made at the same time, so as to deal with a stolen or lost card. As the cardholder authentication, the hand-written signature of the buyer is verified against the signature on the back of the card, for example. The storekeeper can thus confirm that the buyer is the rightful cardholder by conducting verification by comparing the signature hand-written on the card bill with the signature on the back of the card.

Authentication in Access Control

In the case of access to a computer system, access control is normally performed in order that users be allowed to obtain access only to information to which the users have been granted access. Access control is performed according to a registration indicating who has access permission to which files, and is based on the essential premise that the system operator confirms users' identities. Such confirmation is made by comparing a password provided during login, with a password that has been registered beforehand during user registration.

Authentication for Entrance/Exit

Control of entrance to a physical facility, not to a computer system, is also performed on the very same principle. Only those who have been registered in advance with the facility manager are permitted to enter the facility. When entering, whether a person is an individual who has been registered is verified by visual confirmation of an identification card, or by a fingerprint verification system, password, or the like.

### PROBLEMS THAT THE INVENTION INTENDS TO SOLVE

Nevertheless, the above-mentioned conventional authentication systems have the following fundamental drawbacks.

A person making deposit-information confirmation or a withdrawal from his/her account, or sending/receiving information through communications lines such as on the Internet, needs to be authenticated as being the individual person who has made the contract. For the authentication, an authentication number/authenticator that has been determined previously by the individual person is normally verified for a match each time. This kind of authentication has the advantage of being registered quite easily, and in addition its verification procedures can be easily conducted.

Under the present circumstances in which networking has been promoted for all media, as the number of items for which various kinds of authentication numbers and authenticators have to be determined has increased, it has become difficult to remember such numerous authentication numbers and authenticators. For this reason, a person has to determine for each of the items a specific number or authenticator that the person finds easy to remember, or has to write down the authentication numbers and authenticators on something to be kept. These acts, however, increase the risk of theft of the authentication number(s) and authenticator(s).

### DISCLOSURE OF INVENTION

An object of the present invention is to provide an authentication system, which reduces the risk of theft by a third party, and to provide an authentication request device, a verification device and a service medium for use in the authentication system.

A first inventive authentication system is for use by an authenticator to authenticate legitimacy of an authentication requester in response to a request from the authentication requester. The first inventive authentication system includes: encrypted-information preparing means for receiving fixed authentication-requesting information that is unique to the authentication requester, and variable information that has characteristics varying with respect to time, so as to prepare encrypted information based on the fixed authentication-requesting information and the variable information, and information decoding means for receiving fixed authenticating information corresponding to the fixed authentication-requesting information, and the encrypted information, so as to decode at least the fixed authentication-requesting information from the encrypted information.

Accordingly, the fixed authentication-requesting information merely passes through the authentication system, and the fixed authentication-requesting information does not have to be stored in the authentication system, making it difficult for a third party to detect the fixed information that is unique to the authentication requester. Further, the encrypted information includes the variable information that varies in accordance with the location where the authentication requester is and what time it is then, etc., making it more difficult for a third party to steal the fixed information. Therefore, the possibility of theft by a third party in using the authentication system can be reduced.

The authentication system further includes first fixed-information storing means for storing another fixed authentication-requesting information that is unique to the authentication requester, and another fixed-information storing means for storing another fixed authenticating information that corresponds to said another fixed authentication-requesting information, and in the authentication system, the encrypted-information preparing means prepares the encrypted information including said another fixed authentication-requesting information as well, and the information decoding means decodes said another fixed authentication-requesting information as well. Then, the risk of theft by a third party is further reduced.

The authentication system further includes collating means for receiving outputs from the information decoding means and said another fixed-information storing means, so as to compare said another fixed authentication-requesting information for agreement with said another fixed authenticating information. Then, authentication reliability increases.

In the authentication system, the information decoding means decodes the variable information as well, and the authentication system further includes determining means for receiving the decoded variable information to determine based on the variable information whether the authentication requester is legitimate. Then, authentication reliability further increases.

In the authentication system, the encrypted-information preparing means also uses public information for encryption so as to prepare the encrypted information, and the information decoding means also uses public information for decryption so as to perform the decoding. Then, the encrypted-information preparing and decoding operations can be performed smoothly.

In the authentication system, the authenticator is a plural presence, and the fixed authentication-requesting information is made common to each of the authenticators. Then, complexity, such as use of numerous secret codes by the authentication requester, is avoidable, while the risk of theft by a third party is reduced.

In the authentication system, the encrypted-information preparing means and the information decoding means are incorporated into a single medium, and the medium further includes a circuit for generating at least one of a sound signal and an image signal, and control means for receiving the decoded fixed authentication-requesting information to control, based on the fixed information, the circuit to be operational or non-operational. This allows the authentication system to be constructed to be suitable for video-distribution and audio-distribution services.

A second inventive authentication system is for use by an authenticator to authenticate legitimacy of an authentication requester in response to a request from the authentication requester. The second inventive authentication system includes: encrypted-information preparing means for receiving variable information that has characteristics varying at least with respect to time, so as to prepare encrypted information based on the variable information, and information decoding means for receiving fixed authenticating information corresponding to fixed authentication-requesting information, and the encrypted information, so as to decode at least the variable information from the encrypted information.

Accordingly, the encrypted information includes only the variable information that varies in accordance with the location where the authentication requester is and what time it is then, etc., making it more difficult for a third party to steal the information of the authentication requester. Therefore, the possibility of theft by a third party in using the authentication system can be reduced.

When the authentication system further includes: registered-information storing means for storing registered information for use in determining whether the variable information is appropriate or not, and appropriateness determining means for determining whether the decoded variable information is appropriate or not, based on the registered information, authentication can be conducted easily.

An inventive authentication request device is an authentication request device in an authentication system for use by an authenticator to authenticate legitimacy of an authentication requester in response to a request from the authentication requester. The inventive authentication request device includes: a variable-information input unit for receiving variable information that has characteristics varying with respect to time, and encrypted-information preparing means for receiving the variable information from the variable-information input unit, so as to prepare encrypted information based on the variable information.

Accordingly, the encrypted information includes only the variable information that varies in accordance with the location where the authentication requester is and what time it is then, etc., making it more difficult for a third party to steal the information of the authentication requester. Therefore, the possibility of theft by a third party in making authentication request can be reduced.

The authentication request device preferably further includes a fixed-information input unit for receiving fixed authentication-requesting information that is unique to the authentication requester, and the encrypted-information preparing means preferably prepares the encrypted information based on the fixed information and the variable information.

In that case, the fixed authentication-requesting information also merely passes through the authentication request device, and does not have to be stored in the authentication request device, which makes it difficult for a third party to detect the fixed information that is unique to the authentication requester.

The authentication request device further includes: first fixed-information storing means for storing another fixed authentication-requesting information that requires confidentiality unique to the authentication requester, and second fixed-information storing means for storing another fixed authenticating information corresponding to said another fixed authentication-requesting information, wherein the encrypted-information preparing means prepares the encrypted information including said another fixed authentication-requesting information as well. Then, the risk of theft by a third party is further reduced.

When said another fixed information is prepared based on image information which identifies the authentication requester, a forgery of the fixed information by a third party becomes difficult.

In the authentication request device, the variable information is preferably determined based on a GPS (global positioning system), or the variable information is preferably determined based on information from a mobile information terminal and a mobile base station.

A first inventive verification device is a verification device in an authentication system for use by an authenticator to authenticate legitimacy of an authentication requester in response to a request from the authentication requester. The first inventive verification device includes: an encrypted-information input unit for receiving encrypted information which is transmitted from the authentication requester, and which is prepared based on variable information and fixed authentication-requesting information that is unique to the authentication requester, a fixed-information input unit for inputting fixed authenticating information corresponding to the fixed authentication-requesting information, and information decoding means for receiving outputs from the encrypted-information input unit and the fixed-information input unit, so as to decode at least the fixed authentication-requesting information from the encrypted information.

Accordingly, the fixed authenticating information merely passes through the verification device, and does not have to be stored in the verification device, making it difficult for a third party to detect the fixed information that is unique to the authentication requester. Further, the encrypted information includes the variable information that varies in accordance with the location where the authentication requester is and what time it is then, etc., making it more difficult for a third party to steal the fixed information. Accordingly, the possibility of theft by a third party in verification can be reduced.

In the verification device, the encrypted information that is transmitted from the authentication requester includes another fixed authenticating information corresponding to the fixed authentication-requesting information, and the verification device further includes fixed-information storing means for storing said another fixed authenticating information corresponding to said another fixed authentication-requesting information, and collating means for receiving outputs from the information decoding means and the fixed-information storing means, so as to compare said another fixed authentication-requesting information for agreement with the fixed authenticating information. Then, verification reliability increases.

When the information decoding means decodes the variable information as well, and the verification device further includes determining means for receiving the decoded variable information to determine legitimacy of the authentication requester based on the variable information, verification reliability further increases.

A second inventive verification device is a verification device in an authentication system for use by an authenticator to authenticate legitimacy of an authentication requester in response to a request from the authentication requester. The second inventive verification device includes: an encrypted-information input unit for receiving encrypted information prepared based on variable information transmitted from the authentication requester, and information decoding means for receiving an output from the encrypted-information input unit, so as to decode at least the variable information from the encrypted information.

Accordingly, the encrypted information includes only the variable information that varies in accordance with the location where the authentication requester is and what time it is then, etc., making it more difficult for a third party to steal the fixed information. Therefore, the possibility of theft by a third party in verification can be reduced.

When the verification device further includes registered-information storing means for storing registered information for use in determining whether the variable information is appropriate or not, and appropriateness determining means for determining whether the decoded variable information is appropriate or not, based on the registered information, verification can be conducted easily.

A first inventive service medium is a medium in an authentication system for use by an authenticator to authenticate legitimacy of an authentication requester in response to a request from the authentication requester. The first inventive service medium includes: a fixed-information input unit for receiving fixed authentication-requesting information that is unique to the authentication requester, a variable-information input unit for receiving variable information that has characteristics varying with respect to time, encrypted-information preparing means for receiving the fixed authentication-requesting information and the variable information, so as to prepare encrypted information based on the fixed authentication-requesting information and the variable information, information decoding means for receiving fixed authenticating information corresponding to the fixed authentication-requesting information, and an output from the encrypted-information preparing means, so as to decode at least the fixed authentication-requesting information from the encrypted information, a circuit for generating at least one of a sound signal and an image signal, and control means for receiving the decoded fixed authentication-requesting information to control, based on the fixed information, the circuit to be operational or non-operational.

Accordingly, the fixed authenticating information merely passes through the service medium, and does not have to be stored in the service medium, making it difficult for a third party to detect the fixed information that is unique to the authentication requester. Further, the encrypted information includes the variable information that varies in accordance with the location where the authentication requester is and what time it is then, etc., making it more difficult for a third party to steal the fixed information and use the audio signal or video signal. Accordingly, the possibility of theft by a third party in enjoying the service can be reduced.

A second inventive service medium is a medium in an authentication system for use by an authenticator to authenticate legitimacy of an authentication requester in response to a request from the authentication requester. The second inventive service medium includes: a variable-information input unit for receiving variable information that has characteristics varying with respect to time, encrypted-information preparing means for preparing encrypted information based on the variable information, information decoding means for receiving an output from the encrypted-information preparing means, so as to decode at least the variable information from the encrypted information, a circuit for generating at least one of a sound signal and an image signal, and control means for receiving the decoded variable information to control, based on the variable information, the circuit to be operational or non-operational.

Accordingly, the encrypted information includes only the variable information that varies in accordance with the location where the authentication requester is and what time it is then, etc., making it more difficult for a third party to steal the fixed information and use the audio signal or video signal. Therefore, the possibility of theft by a third party in enjoying the service can be reduced.

### BRIEF DESCRIPTION OF DRAWINGS

FIG. 1 is a block diagram schematically showing authentication flow in a general authentication system.

FIG. 2 is a block diagram schematically showing the overall configuration of, and information flow in an authentication system according to a first embodiment of the present invention.

FIG. 3 shows a block diagram schematically showing the configuration of an authentication request device according to a second embodiment of the present invention.

FIG. 4 is a block diagram showing the configuration of a variable-information detection unit in a hand-held terminal in the second embodiment of the present invention.

FIG. 5 is a block diagram showing an example of the configuration of a verification device 16B according to a third embodiment of the present invention.

FIG. 6 is a block diagram schematically showing the configuration of an authentication system according to a fourth embodiment of the present invention.

FIG. 7 is a block diagram schematically showing the configuration of an authentication system according to a fifth embodiment of the present invention.

### BEST MODE FOR CARRYING OUT THE INVENTION

—Basic Authentication Systems—

Authentication normally means an act in which an authentication requester who registers himself/herself beforehand as an entity(ies) to be authenticated, is identified and verified, by showing proof thereof, as being the entity(ies), i.e., the rightful person. Note that the term “an authentication requester” (a person to be authenticated) in the present invention includes not only an individual person but also individual persons, companies, associations, various organizations, and groups, for example, and thus hereinafter these will be collectively referred to as an “entity(ies).” Also note that the act of registration herein is performed for a purpose of some kind, and the authentication of the entity(ies) is also conducted for a purpose of some kind (which is normally the same as that of the registration).

For example, assume that an entity(ies) wants to enjoy a service (here, service in a quite wide meaning) that is available for only a previously specified entity(ies). In this case, the entity(ies) who requests to receive the service cannot enjoy the service until the requesting entity(ies) is verified as being the entity(ies) who has the right to enjoy the service. In this system, authentication becomes necessary, and the above-mentioned purposes in this case are to enjoy the service.

1. Principles of Authentication

As described above, authentication is an act to confirm that an authentication requester is a pre-enrolled entity(ies), i.e., it is an act to confirm the legitimacy of the authentication requester. This act requires a process in which the requester is made to prove in some way himself/herself to be the pre-enrolled entity(ies). There are several ways, which will be described later, in which this proving is done. First, the authentication requester has to present information or a thing (presented information) which is necessary for making the proof As a part of a registration procedure, the requester also needs to register information (registered information) which is used in making the proof. The presented information is compared with the registered information in order to verify that the authentication requester is a pre-registered entity(ies). Authentication in general is based on this principle. When an object is to be used as the registered information, the object has to be issued by the registering party during registration, and the verification is conducted by confirming that the object is the actual object that has been granted to the entity(ies).

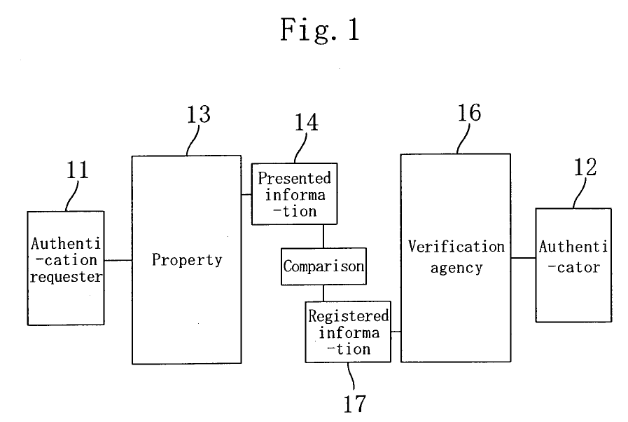

FIG. 1 is a block diagram schematically showing authentication flow in a general authentication system.

As shown in FIG. 1, when an authentication requester 11 shows presented information 14 from among his/her property 13, a verifier or verification system (verification agency 16) that conducts verification at request of an authenticator 12 presents registered information 17 in order that authentication be conducted by making a comparison between the presented information 14 and the registered information 17.

The basic elements of the authentication system shown in FIG. 1 may be defined as follows.

Authentication requester: An entity(ies) who claims to be an entity(ies) who has been registered.

Verifier: Person (or a system) for verifying the claim of the authentication requester based on evidence.

Authenticator: Person who makes a final conclusion based on a comparison check to verify the authentication requester as being the entity(ies).

Registered information: Information that is registered as evidence, based on which verification is made during authentication, and that is for use by the verifier.

Presented information: Information that is presented as evidence by the authentication requester (i.e., information to be compared with the registered information by the verifier for verification).

2. Authentication Method

Authentication methods are classified into the following methods according to what is used as information for showing the identity of an entity(ies).

A. In the Case of an Individual Person

Biometrics I

This type of biometric authentication in particular employs parts of the human body that represent biological traits and that no one can alter intentionally. Specifically, the parts that represent such biological traits include the face, fingerprints, blood-vessel arrangements in the retina, and iris patterns, for example.

The Face

There are differences among individuals in their faces. Authentication techniques using facial characteristics are thought to be the earliest authentication techniques utilized. When a computer is used for authentication, an image (picture) of a face is compared for a match. However, facial images used as registered information and facial images as presented information that are taken during authentication differ in time, place and other image-capturing conditions. In a comparison between facial images, therefore, the fact that the images simply match each other is not enough. It is necessary to extract various characteristics to confirm that the respective characteristics extracted from the images match each other.

There have been reported research examples in which the outside shape (the contour) of the face, the shapes of the eye, nose and mouth, and the topography of the face, for example, are used as facial characteristics. Personal identification using the face is still being studied, as are algorithms for such identification, but to date, products available for consumer use have not yet been announced.

The Retina

Blood vessels existing in the retina are visible from the exterior, and the pattern of the blood vessels on the retina is unique for each individual. It is thus said that the retina can be used for individual identification. Scanning of the blood-vessel pattern on the retina requires an authentication requester to position his/her eyes close to a special device, and the retina has to be then illuminated by light from the exterior. Authentication techniques using the retina can be considered to be technology that has been established to some extent. Eyedentify, Inc., in the United States has put products on the market that have had a considerable track record in use. Nevertheless, retina scanning requires a special device, resulting under present circumstances in its applicability being limited only to entrance/exit control or similar control.

The Iris

Like the retina, the iris, which is part of the eye, is said to exhibit a unique pattern in each person. The retina is located at the back of the eye and is not visible unless the eye is positioned close to a special device and illuminated by light from the exterior. On the other hand, the iris is visible on the surface of the eye and is easily viewed without using a special device. This enables an image of the iris to be taken by a general-purpose image-capturing device, such as a conventional video camera or digital camera, such that an advantage to iris scanning is that it can easily be implemented in authentication systems.

The Ear

Research reports on differences among individual persons in the shape of their ears have been made in Europe and America as well as in Japan, and the shape of the ear is said to be unique to each person. Moreover, the size of the ear with respect to its length and width becomes constant after sixteen to seventeen years of age. Although the ear may grow slightly thereafter, it may be regarded as invariable throughout the owner's life. However, further research will be necessary in order to confirm whether the ears of parent and child, of sisters, of brothers, or of twins can be discriminated from each other, that is, in order to verify whether the shape of the ear is unique for each person even from a genetic aspect.

At present, based on the premise that the shape of the ears is unique for each individual, many experiments have been made to recognize/identify, the shape of the ear, and algorithms for recognition/identification are also being investigated. For these reasons, inasmuch as research on ear-shape authentication, including its feasibility, is still being conducted, ear-shape authentication, which has potential, has not at this stage come to be practicable.

Fingerprints

Every person's fingerprint is said to be unique. Fingerprint authentication techniques are the most reliable among biometric methods for personal identification. Although fingerprint personal identification methods have since long ago been established in the field of forensic science, what remained unestablished were methods using computer processes. However, many experiments have been made in order to use fingerprints in computer-processing authentication systems. As a result, the utilization of fingerprints may be considered from the technical point of view to have been almost established. Authentication techniques of this kind have already been commercialized and put to practical use by various manufacturers. These techniques can be classified roughly into minutiae matching and global-pattern matching. There seems to be a larger number of products based on minutia matching.

Manufactures that have already announced such products include Fujitsu Ltd., Mitsubishi Electric Corp., NEC Corp., Sony Corp., Nissho Iwai Corp., LSI Card Corp., Hamamatsu Photonics K.K., Kabushiki Kaisha Matsumura Electronics, Yamatake-Honeywell Co., Ltd., Tsubasa System Co., Ltd., and SECOM Co., Ltd.

Palm Prints Authentication techniques using palm prints employ characteristics of the pattern of lines on the palm, but since the palm does not have as many minutiae as the fingers, individual identification accuracy is lower as compared with fingerprints. Moreover, it is generally considered that each person's palm prints are not as unique as his/her fingerprints. Fields in which palm prints can be used for authentication are thus necessarily limited. Authentication techniques using palm prints have been adopted in several products, including some under development, and are presumed to be applicable in situations such as entrance/exit control in which the conditions required are relatively relaxed.

Shape of Flat-of the Hand Contour

Whereas palm-print authentication employs features of what is commonly called palm reading, authentication techniques exploiting the contour of the flat of the hand—this contour being the so-called hand geometry—capture and make use of the width and length of the palm, the length and shape of the fingers, and other traits. The contour of the hand, as is the case with palm prints, is not considered to have the identifying individuality of fingerprints, but the contour of the hand being easy to employ, presumably will turn out to be applicable to limited situations such as entrance/exit control and the like. At present, authentication techniques using flat-of-the hand contour have been adopted in several products by a number of foreign and domestic companies, with proven results when used in entrance/exit control at the Olympics in Atlanta.

Recognition Systems, Inc., BioMet Partners, Inc., Bio-metric Security Sys, and Mitsubishi Electric Corp. have announced systems using this kind of technique.

Finger Shape

Authentication techniques using the shapes of the fingers focus on variations among individual persons in the length of the finger sections that are divided by the knuckles. In Japan, since long ago there has been a system that in concept is similar to that of these techniques, in which illiterate persons make use of the shapes of their fingers in place of signatures. As is the case with palm prints and flat-of the-hand contour, because finger shape has not been proved to have the identifying individuality of fingerprints, its applicability for authentication is considered to be limited. At present, only Toshiba Corp. has introduced products into which this type of technique has been incorporated as an entrance/exit control system.

Biometrics II (Signatures/Handwriting, Voiceprints, etc.)

Biometrics II systems use biological traits in the broad sense. The fact that the biological traits used can be altered intentionally allows a potential forger to use such traits in order to pose as the rightful person. Signatures (handwriting) and voiceprints come under Biometrics II.

Voiceprints

An act of vocalization, which involves a voluntary element, is not necessarily reproducible. In authentication techniques using voiceprints, special care has to be given in order to reduce the differences between voiceprints captured during registration and during authentication. A sound signal is data on changes with respect to time in sound pressure, while a voiceprint graph is data on changes with respect to time in a frequency spectrum obtained by analyzing the sound pressure into its frequency components. A comparison between voiceprints is made by capturing voiceprint data of a word for which voiceprint data has been registered, and seeking a match between the two. As described above, since a voiceprint is not necessarily reproducible, voiceprints are compared for a match not by simply superimposing the voiceprint data, but by recognizing and extracting respective characteristics of the speakers in order to seek a match between the characteristics. In this technique, the degree of reproducibility varies depending on the word to be registered. Words that a speaker is accustomed to vocalizing are said to be highly reproducible. For this reason, in some instances individual names are used for authentication.

One example of the practical application of authentication using a voiceprint is “Voice Phone Card,” of Sprint Inc., in the United States. “Voice Phone Card,” which is a credit card system for public telephones, has been realized using technology by Texas Instruments, Inc. Adopted in this system is a method in which a user vocalizes a ten-digit social security number according to a guide message. In Japan, Fujitsu Ltd., has announced a system called “telephone banking.” Although the study of sound for the purpose of voice recognition has a long history, voice-recognition-based personal identification/recognition and related algorithms for authentication purposes are still being investigated.

Signatures

Authentication techniques using signatures utilize a writer-verification technique in writer-recognition technology. The writer recognition technology is both writer identification and writer verification technology. The writer identification method is a technique in which the writer is identified among a plurality of specified persons from handwriting, while the writer verification method is a technique for verifying the writer as being a specific person. In the writer verification method, handwriting (that is, a signature in this case) of a target person is pre-registered, and handwriting in question is compared with the pre-registered handwriting for determination of similarity.

Signature verification may be either static, in which only the shape of handwriting is considered, and dynamic, in which stroke order, pressure, speed, etc. are considered. Naturally, more information can be used in the dynamic signature verification approach. In this case, handwriting has to be made on a special device such as a tablet. Many of the authentication techniques that have been put to practical use adopt the dynamic signature verification approach. An example of its practical application is Cyber-sign by CADIX Inc.

Biometrics II is characterized in that Biometrics II uses traits that can be intentionally altered by an individual person, while Biometrics II uses traits that cannot be intentionally altered by an individual person. Specifically, fingerprints and other characteristics cannot be forged, while characteristics of other person's handwriting and voice can be imitated.

In authentication techniques using Biometrics II, presented information produced by imitating the signature or voice of an individual person needs to be excluded. In this regard, the fact that Biometrics II differs greatly from Biometrics I in test methods must be borne in mind.

B. In the Case of Individual Persons, Companies, Associations, and Various Organizations.

In the case of individual persons, companies, associations, and various organizations, when a representative person alone is registered for authentication, or when each of the individual persons, or each of the members of the companies, associations, various organizations, and groups is individually registered for authentication, the authentication methods described above for the case of an individual person are applied without alteration.

On the other hand, when registration for authentication is made as a company or an organization, a company seal, a mark of such organization, and other two-dimensional patterns or a code number can be used as registered information for authentication. In this case, as in Biometrics II, how to prevent forgery becomes crucial.

3. Possessions

Authentication using “something a person possesses” is a technique that had been widely used as a means of authentication before computers were available. A specific example is a system in which a passport, an identification card, a driver's license, a membership card, a credit card, or the like is used. Authentication based on “something a person possesses” is based on the idea that a thing for identifying an entity(ies) is issued and a person who possesses the issued thing is verified as being the entity(ies). Purely possession-based authentication involves the risk of a fraudulent person posing as the rightful person in the case of theft or loss. In order to lessen the risk, separate authentication based on “something the person is” is often made at the same time. The face photo in a passport, identification card, or driver's license is registered information for the authentication based on “something the person is.” Also, in the case of a credit card, something-a-person-is-based authentication using a signature is adopted. At a bank, authentication using a bank cash card falls into the category of authentication based on “something a person possesses,” while a personal identification number is used to perform authentication based on “something the person is.”

In the computer world, a magnetic card or an IC card is often used for storing a password or an encryption key. From an operational aspect, this kind of authentication corresponds to purely possession-based authentication that does not involve authentication based on “something a person is”. However, the card is used merely as an auxiliary memory for storing information that cannot be memorized by the user, and from the viewpoint of authentication technique classification, authentication using these kinds of cards should be classified as authentication using confidential information.

Moreover, purely possession-based authentication is meaningless for authentication via a network. Specifically, no information other than electronic information can be presented to the person at the other end on a network, and since electronic information can be freely copied, it is clear that purely possession-based authentication cannot in principle be realized. Accordingly, possession-based authentication via a network has to be a method in which authentication based on “something a user is” is also conducted via the network so that the person having “something the user possesses” is indirectly identified. This technique is therefore classified in accordance with the method employed to conduct the something-the-user-is-based authentication.

4. Secret Information 1

Methods using secret information are authentication means that have been used since as long ago as authentication based on “something a person possesses” has been. In the computer world, this is a system called “password” or “personal identification number/PIN.” Authentication using a password or other secret information may be said to be an established technique, and thus nothing in this technique remains for further study. Secret information in which presented information can be generated from registered information is classified as Secret information 1.

As networks used have shifted from conventional closed environments to open environments, a simple password system allows a fraudulent user to easily pose as a rightful user by a wiretapping-and-replaying technique. In view of this, methods in which no bare passwords are transmitted on a network have been studied and put into practical use.

Among those, the oldest system devised is a system called “one time password,” and there are other systems as follows. Each of these systems has been put to practical use and become commercially available.

Challenge-Response System

An authenticating party presents a random number sequence called a “challenge” and the authentication requester adds a given manipulation/conversion to the random number sequence so as to generate and send back a code, which is called a “response.” The given manipulation/conversion, which is different for each user, has been registered on the authenticating side. In other words, the manipulation/conversion procedure is nothing other than individual information.

The random number sequences to be presented are varied each time and thus, even if these sequences are wiretapped by monitoring the network, the wiretapped sequences cannot be used for replay. The manipulation/conversion procedure is very complicated, and the amount of information in the procedure is too large to memorize, leading to the problem of deterioration in operability in manually running the procedure each time. For this reason, this system is often implemented in such a manner that the function of converting a challenge into a response is incorporated in a hand-held device as a calculator.

This system itself is not new, and was already adopted in ETSS, which was prototyped in Japan during the fourth decade of the Showa Era.

An encryption function can be used as the manipulation/conversion procedure. In that case, the registered information is (an algorithm and) an encryption key.

Time Synchronous System

In this system, a hand-held device similar to that used in the challenge-response system is used. However, there is no challenge, and an internal clock at the authenticating end is synchronized with a clock to the hand-held device in order to utilize a time-dependent password generated as a time function by both sides. Specifically, the user inputs as a password (presented information) what is being displayed at that point in time on the hand-held device, while the authenticating party generates a password (registered information) based on what time it is then, and on the ID of the user, in order to seek a match for verification.

5. Secret Information 2

With regard to what is classified as Secret information 1, if registered information has become known, presented information can be generated from the registered information. Thus, what is classified as Secret information 1 is safe in a one-to-one or one-to-n relationship, but not necessarily safe in an n-to-n relationship, such as in electronic commerce. A method in which revealed registered information does not lead to generation of presented information is classified as Secret information 2.

In systems using digital signatures, for example, being essentially the same as Secret information 2, what is registered is a public key, while what is presented is information signed with a secret key associated with the public key. Even if a person obtains the registered public key, the person cannot generate the information for presentation. In view of this, systems using digital signatures are distinguished and classified as a different category. Systems using zero-knowledge techniques also fall under this category.

Another system used is Kerberos, which has been developed by the Massachusetts Institute of Technology in the United States in order to solve the problem of the complexity of having a password for each server and the danger of bare passwords being sent/received on networks in client/server applications. This system is based on the idea that authentication servers are provided in addition to separate function servers, and a client makes the authentication servers issue electronic credentials (called “tickets”) for him/her in order to access the target function servers, and the client presents the issued tickets to the target servers. This system is also classified under third party authentication systems.

The tickets may also be thought of as a kind of authentication based on “something a person possesses,” that is performed in conjunction with something-a-person-is-based authentication using secret key cryptography. Note that expiration dates are set for the tickets. This system is actually used in client/server systems based on UNIX, but has not become mainstream in the EC environments at the present stage.

First Embodiment

In view of a background as is noted above, what will be described in this embodiment is technology wherein, in an instance of determining a personal code, not only predetermined information on an individual (including recollections and possessions) is employed as has been conventional, but also information on the location where the individual person is and information on what time it is then, are employed as variable information, and wherein authentication is performed based on these sets of information. What will be described specifically is a system wherein a personal secret code into which variable information as well is incorporated is prepared by a special information preparation means when authentication is necessary, and authentication information on the individual is decoded based on part of pre-registered information on the individual person and based on information for decoding determined in preparing the authentication information, so as to conduct the authentication using the decoded authentication information along with real-time information on the individual person, whereby the course of the location and time information can be traced, and the accuracy of the authentication is heightened and theft of the personal number/symbol code is prevented to a higher degree.

Note that although authentication of an individual person will be described as an example in this embodiment, the present invention is applicable to companies, associations, and various organizations because information on location, time, etc. can be incorporated into the secret code.

Further, although for the sake of convenience information on location is described as being variable in this embodiment, location in the case of an organization, for example, might not be variable. In such a case as well, even if a third party were to use an organizations' code number, etc. from a different location, the present invention would prevent impersonation as the organization. Thus, variable information under the present invention does not necessarily have to be information on shifting of location, but may be information on change in time.

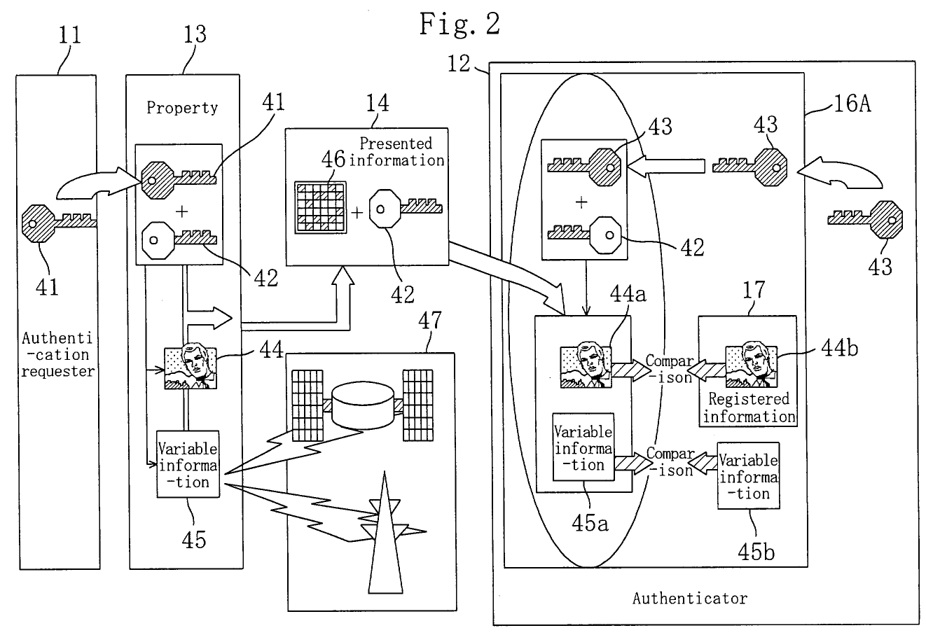

FIG. 2 is a block diagram schematically showing the overall configuration of, and information flow in an authentication system according to a first embodiment of the present invention.

An authentication requester 11 holds an encryption key 41 for requesting authentication. The encryption key 41 is first fixed information that is unique to the authentication requester. A public key 42 and biometrics information 44 are stored in property 13 of the authentication requester 11. The public key 42 is determined by an appropriate encryption process and corresponds to the individual person. The biometrics information 44, which exploits biometrics such as described above, is second fixed information that is unique to the authentication requester. The encryption key 41 is not stored in the property 13, and, is merely input every time when there is a request for authentication. The property 13 functions to receive variable information 45 from a variable-information provider 47 such as a GPS system that works using three satellites, or a base station for cell phones. The property 13 also functions to prepare presented information 14 using the variable information 45. Nevertheless, the property 13 need not function to produce the presented information 14, and thus there may be a separate device which functions to produce the presented information.

Further, an authenticator 12 is provided with a verification unit 16A in this example. However, a verification agency that includes verifiers and verification devices, for example, may be present aside from the authenticator 12. The authenticator 12 holds, by prearrangement with the authentication requester 11, an encryption key 43 for authentication. The encryption key 43 is information on the individual person. Since the authenticator 12 includes the verification unit 16A in this example, the encryption key 43 for authentication is stored in the verification unit 16A. Registered information 17 such as the biometrics information 44 provided by the authentication requester 11 is also stored in the verification unit 16A. It should be noted that the encryption key 43 does not necessarily have to be stored in the verification unit 16A, but may be input by the authenticator during authentication.

Specifically, the authentication requester 11 readies, as the encryption key 41 for requesting authentication, the first fixed information, which is stored separately from the property 13, and in accordance with the encryption formula readied on each such occasion, the authenticator 12 determines from the encryption key 41 the authentication encryption key 43, which is unique to the authenticator, and the public key 42, which is a common key unique to both. It is preferable that the public key 42 determined by the authentication requester 11 be registered with the authenticator 12 or the verification unit 16A. Further, as in this example, the property 13 is preferably registered for ease of operation. So long as the property 13 herein has the above-mentioned functions, it does not necessarily have to be a special device and may be something that the addition of second fixed information such as the biometrics information 44, manifests individuality. Moreover, the authenticator 12 preferably has the second fixed information such as the biometrics information 44, registered in the verification unit 16A.

The authentication requester 11, which requests authentication using the property 13, needs to prepare a secret code on each such occasion. When the encryption key 41 for requesting authentication is input into the property 13, the encryption key 41 for requesting authentication and the public key 42 (public information for encoding) are combined, whereby encrypted information 46 is computed from the biometrics information 44 pre-registered in the property and the variable information 45 on change in location, time, etc.

Next, the computed encrypted information 46 and the public key 42 are transmitted as the presented information 14 to the verification unit 16A. Alternatively, the presented information 14 may be presented to the authenticator 12 and then sent to the verification unit 16A from the authenticator 12.

In the verification unit 16A, the encryption key 43 for authentication is selected with the presented public key 42 (public information for decoding) as a clue, and the authentication encryption key 43 and the public key 42 are used for decoding the encrypted information 46. Biometrics information 44a in the decoded information is then compared with biometrics information 44b pre-stored in the registered information 17. Authentication of the individual person is completed when whether the biometrics information 44a and 44b coincide with each other or not is determined. It is also determined whether decoded variable information 45a on location, time, etc. coincides with variable information 45b calculated in the verification unit 16A based on time, etc. The decoded variable information 45a on location, time, etc. is stored for a given period of time to be used as tracking information on the individual person. It should be noted that the variable information 45a does not have to be used for the authentication.

The following functional effects can be attained by the authentication method in this embodiment. When the authentication requester 11 requests authentication, he/she first needs to input information for requesting authentication into the property 13. In conventional techniques, information corresponding to the encryption key 41 that is the first fixed information (or the encryption key 41 as the first fixed information and the biometrics information 44 as the second fixed information) is directly used for verification, and thus remains as a default value in the property 13. In contrast, in this embodiment, due to the fact that the first fixed information is utilized only as the encryption key 41, which is volatile information when requesting authentication, the first fixed information does not remain as a default value in the property 13. This remarkably reduces the possibility of theft of the first fixed information by a third party.

The biometrics information 44 that is the second fixed information does not necessarily have to be used, but using it ensures that abuse of the system by a third party is more surely prevented.

Furthermore, in this embodiment, the property 13 detects the variable information 45 on location, time, etc. when an authentication request is made, and the detected variable information 45 is combined with the biometrics information 44 stored as the second fixed information in the property 13. And the property 13 uses the encryption key 41 as the first fixed information and the public key 42, so as to prepare the encrypted information 46 from the variable information 45 and the biometrics information 44. The prepared encrypted information 46, to which the public key 42 is added, is transmitted as the presented information 14 to the verification unit 16A. As described above, in this embodiment, the encrypted information 46 in the presented information 14 is prepared by adding the variable information 45 to the biometrics information 44. Even if a third party should detect the presented information 14 from a signal during an authentication request, it would therefore be difficult to extract the biometrics information 44 from the presented information 14. Accordingly, this embodiment makes it possible to curtail the risk of a third party posing as the authentication requester 11 and succeeding at authentication.

In addition, in this embodiment, the verification unit 16A uses the public key 42 to select from the authenticator 12 the authentication encryption key 43 that is unique to the authentication requester. These two keys are then used to decode the biometrics information 44a and the variable information 45a on location, time, etc., which is variable information. The verification unit 16A then compares the biometrics information 44a and 44b with each other, and compares the variable information 45a and 45b on location, time, etc. with each other. Since the encryption key 43 is not itself the encryption key 41 for requesting authentication, abuse by a third party is prevented more reliably as compared with conventional techniques.

Also, the variable information 45a and 45b may be stored for a given period of time. In such a case, the variable information 45a and 45b have the advantage of being usable as action-tracking information on the authentication requester 11 to prove that the authentication requester 11 was present at a specific location at the time the authentication request was made, for example.

It should be noted that when the encrypted information 46 goes through the verification unit 16A a long time after the authentication has been completed, the above-described authentication operation is preferably performed periodically or a periodically. In such a case, in particular, it is preferable that the biometrics information 44a and 44b and the variable information 45a and 45b that are action-tracking information on an individual person, be used for authentication.

It should also be noted that although in this embodiment the authentication requester devises the timing for the detection of the variable information on location, time, etc., there may be cases in which the timing is designated by the authenticator. Since the variable information on location, time, etc. is added into the secret code, even should a third party intercept the information sent/received between the two and attempt to gain access to the authentication system from another location at another time, it would be extremely difficult for the third party to be successfully authenticated.

Furthermore, in a case in which a third party tries to use the property, since the third party does not have the first fixed information, i.e., the encryption key 41 that is separate from the property, the fact that the third party would not be successfully authenticated would be no different in this case either.

The elements constituting the secret code proposed in this embodiment are:

1. first fixed information (encryption key 41 that is possessed separately from the property.)

2. second fixed information (biometrics information 44 that is possessable by incorporation into the property)

3. variable information (variable information on location, time, etc.)

4. encrypted information.

It is preferable that combinations of these elements be changed depending on objectives, for ease of system operation.

A first case is that, as in this embodiment, information into which the second fixed information, i.e., the biometrics information 44, and the variable information 45 have been incorporated is used as encrypted information. In this case, neither the encryption key 41, i.e., the first fixed information, nor the public key 42 is necessarily used, but as in this embodiment, the use of the two keys ensures more reliability.

A second case is a method in which information into which the encryption key 41, i.e., the first fixed information, and the variable information 45 have been incorporated is prepared as encrypted information, and the encryption key 41 and the variable information 45 are decoded. In this case, the decoded encryption key 41 can be compared for a match with the encryption key 43 that has been captured in the verification unit 16A. This is because the encryption key 43 can be readily converted into the encryption key 41. This case is basically similar to the case where the biometrics information 44 and the variable information 45 are incorporated into the encrypted information. The difference between the former and latter cases is that the biometrics information 44b is inevitably stored in the verification unit 16A, while the encryption key 41 does not have to be stored in the verification unit 16A, as will be described in a third embodiment.

A third case is a method in which information into which only the variable information 45 has been incorporated is used as encrypted information. In this case, the variable information 45b for authentication, stored in the verification unit 16A, is preferably registered information that has been pre-registered by the authentication requester 11. For example, if the time for use is predetermined to be in the interval from 2 to 3 o'clock, any authentication request made at any time other than the predetermined time is rejected by comparing the time in the variable information 45 with the predetermined time. Also, a specific region (i.e., a city, a municipal division, or the like) may be predetermined as the location from which request for authentication is made. In such a case, any authentication request made from any location other than the predetermined region will be denied as a result of a comparison between the location in the variable information 45 and the predetermined region. Furthermore, an authentication requester establishing as variable information his/her weight, body temperature, or other personal characteristics that are variable with respect to time would make it difficult for a third party to detect such characteristics, which therefore considerably curtails theft by the third party.

Moreover, an authentication requester may ask a question to a third party so as to use a reply from the third party as variable information. In this case, the third party may be an authenticator, or may be a completely different organization. For example, by using a telephone system in which time is regularly announced, the time when a question is replied to can be used as the variable information.

In the authentication system shown in FIG. 2, the authentication requester 11 in agreeing to use the present system when making an authentication-registration contract with the authenticator 12, will have to have use permission to use the present system from the authenticator 12 or verifier. Billing for use permission can be done at the time a terminal or a server for authentication signal verification, necessary for this system, is sold. Also, a charge may be made for services that utilize this system.

The services available using this system include the following.

Deposits/withdrawals services with financial institutions, such as bank ATM system services, spot-payment-type cashless services, prepaid or credit services, information-distribution services via a network such as the Internet, and services in which action-tracking information that has been encoded and recorded in property is decoded or collected for provision as information on an individual person. In particular, with services pertaining to the broadcast of information via a network, whether wired or wireless, paths for information distribution and paths for authentication may be separate from each other, so that persons sending/receiving information may be authenticated in a safe and effective manner even in situation in which high-density information is broadcasted.

In addition, in the above-mentioned decoding service for the variable information 45 that is the action-tracking information, the authentication requester 11 possessing a hand-held terminal provides the encryption key 41 to a third party, temporarily abandoning ownership of the property 13, e.g., the hand-held terminal, so that the variable information 45 that is the individual person's action-tracking information recorded in the property 13 may be decoded, thereby providing the information as proof of the alibi of the individual person. It should be noted that the variable information 45a (action-tracking information) stored in the verification unit 16A may be decoded. In that case, the decoding service may be carried out by the authenticator.

Second Embodiment

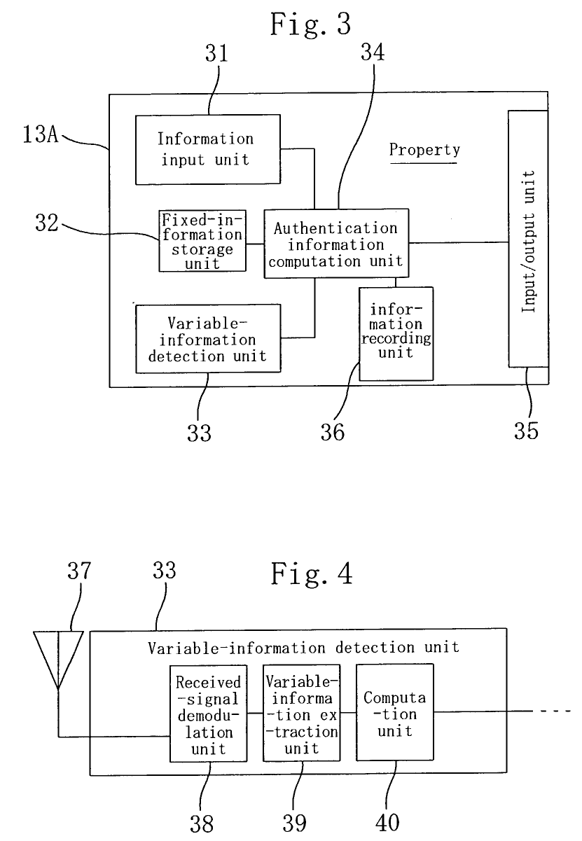

FIG. 3 shows a block diagram schematically showing the configuration, according to a second embodiment of the present invention, of an authentication request device which can be incorporated into the authentication system shown in FIG. 2. In this embodiment, the configuration of a hand-held terminal 13A, which is illustrative of the property 13, will be described as an example. FIG. 4 is a block diagram showing the configuration of a variable-information detection unit in the hand-held terminal.

The elements shown in FIGS. 3 and 4 have the following functions and components. An information input unit 31 for inputting information on an individual person consists of a device which has the functions of a connector, a keyboard, a panel switch, and an image sensor, for example. A fixed-information storage unit 32 consists of a memory device for storing pre-registered information on the individual person, and stores information in which characteristics of the individual to be authenticated are reflected. A variable-information detection unit 33 functions to detect variable information on location, time, etc., and as shown in FIG. 4, includes: e.g., a receiving antenna 37 for receiving an external signal; a demodulation unit 38 that includes a filter, an amplifier, a mixer, an A/D converter, etc., and demodulates the received signal; a variable-information extraction unit 39 for extracting variable information on location, time, etc. from a C/A code from the modulated signal; and a computation unit 40 for temporally storing the variable information on location, time, etc. in order to calculate action trajectories. An authentication information computation unit 34 functions to prepare authentication information based on the information on the individual person and the variable information. An information recording unit 36 is a unit which records related information and in which the authentication (encrypted information 46) prepared in the computation unit and a public key 42 are recorded. An input/output unit 35 functions to output the authentication information externally, and to input external signals. Signals can be input/output not only via a contact-type connector or a contactless reader, but also by means of waves (high-frequency signal) or light. A device for performing external input/output may be selected depending on the pattern of use.

It should be noted that if the variable-information detection unit 33 is designed to be replaceable with a DC (direct conversion) type one-chip device, for example, usability further increases.

The hand-held terminal 13A described as an example of the property does not as a whole have to be physically integrated. For example, the hand-held terminal 13A may be divided in such a manner that part thereof functions as, e.g., an accessory, so long as such an accessory device, together with the other part thereof, fulfills the above-described functions. For example, the receiving antenna may be of patch-type or ring-type, and may be used as an accessory as well. In the case of actual detection of variable information on location, time, etc. in accordance with the present inventions' objectives, a location need not be specified using at least three satellites which support a GPS system, but may be specified based on information from fewer satellites by using an accessory-type device. This is because it has been found that the sphere of action of an individual person can be detected to some extent by such an accessory type device. It has been also found that even if information sent from a mobile information terminal or mobile base station is used instead of information from a GPS system, equivalent variable information on location, time, etc. can be detected.

Simple multi-digit symbols (including numerals) determined by an individual person such as those conventionally used at financial institutions, or specific information such as images of the face of an individual person, patterns, characters or the like, or sounds that are previously mentioned as Biometrics I and II can be used as information on an individual to be stored in the fixed-information storage unit 32. It is preferable that biometric information be pre-stored in the property for easy operation.

It is preferable that in authentication, pre-registered information on an individual person can be input directly to a terminal of a device which performs authentication, or can be input indirectly to the terminal of the device by using property of the individual person such as a hand-held terminal. In addition to that, the individual person's information that has been input by a CCD camera or an image sensor, such as a pressure-sensitive sensor, and then has been made numeric/symbolic by a special information-preparation means, is, more preferably, used for authentication.

When the variable-information detection unit 33 detects variable information on location, time, etc., important are the functions to receive as reference a wave signal or a light signal from the variable-information provider 47, and based on the signal, to compute the location, time, etc. In detecting variable information outdoors, it is preferable that a GPS system, which receives a wave from a communication satellite to detect the location of the receiver, be used. Moreover, in the case of detecting variable information outdoors as well, roaming information which is sent to a hand-held terminal, such as a cell phone or a pager, can also be used to obtain the variable information on location, time, etc. In the case of detecting variable information indoors, the variable information can be captured using an infrared sensor for detecting body temperature of an individual person, a weight detection sensor, or waves or light emitted from a special terminal that the individual person has; and which means is to be used can be selected according to what the equipment implementation is. As the variable information on location, time, etc., not only information at a specific point in time is used, but also tracking information during a given period of time, is preferably included. Using the tracking information during a given period of time, further improves the level of authentication.

In sum, the above-mentioned information that is used for authentication grossly consists of the following four types of information.

(1) First fixed information (that is possessed separately from the property)

(2) Second fixed information (that is possessable by incorporation into the property)

(3) Variable information (that is variable information on location, time, etc.)

(4) Encrypted information (that is prepared at the time an authentication is requested by a hand-held terminal, for example)

The combinations of the information (1) through (4) can be varied as described in the first embodiment.

It should be noted that the public key 42 is not necessarily needed. Further, the biometrics information 44 that is the second fixed information does not necessarily have to be used, but using it ensures that abuse of the system by a third party is more surely prevented.

When the secret code proposed in the present invention is used, risk involved in such a comparison based merely on (1) first fixed information as is conventionally often made at financial institutions, is reduced, and (3) variable information which is the variable information on real-time location, time, etc., allows action trajectory of an individual person to be checked, thereby realizing high-level-authentication, one-time password.

The authentication requester 11 only needs to possess at least part of the first fixed information separately from the property, and thus can hold various kinds of personal codes.

The authentication information computation unit 34 functions to make captured/selected information numeric/symbolic using various types of authentication information preparation means. Examples of the preparation means used herein include not only symmetric encryptosystems, but also common key encryptosystems, typified by DES (Data Encryption Standard) that is an asymmetric system; public key encryptosystems such as the Diffie-Hellman scheme, the RSA scheme, the Merkle-Hellman scheme; and utilization of digital watermarking technology for image information. Nevertheless, the preparation means are not limited to these, and it is preferable that more suitable encryptosystems be incorporated whenever necessary in accordance with objectives.

The public information in the present invention includes common keys, public keys and conversion media for use in digital watermarking technology, for example, but is not limited to these and may be information for encoding and information for decoding.

Comparison using a personal number/symbol code prepared in the above-described manner, is conducted by the following procedures, for example. First, using a hand-held- or accessory-type device in which the above-described various kinds of information has been recorded, a number/symbol code (encryption key 41) which is simple enough for an individual person to remember and which is the pre-registered first fixed information, is input into the information input unit 31 in the authentication request device 13A. At this time, an authentication information preparation means that is incorporated into the authentication computation unit 34, is used to prepare the encrypted information 46 made of numerals/symbols, from the biometrics information 44 in the fixed information storage unit 32 and the variable information 45 captured from the variable-information detection unit 33. Thereafter, the authentication request device 13A transmits via the input/output unit 35 the information to a verification unit connected with a terminal of a device which performs authentication. At the verification unit, as described above, the encrypted information 46 of the individual person can be decoded based on part of the pre-registered authentication information and the information for decoding (i.e., the public key) used in preparing the encrypted information 46.

The variable information 45 on location, time, etc. that is added to the biometrics information 44, not only allows the numbers/symbols of the encrypted information 46, i.e., the information for authentication, to be more complicated, but also effectively works to prevent a forgery or replication of the numerals/symbols constituting the encrypted information.

It should be noted that when the authentication request device 13A is connected to the terminal of the device that performs authentication so as to transmit the information to a center, it is preferable for complication of the information that a simple question be asked to the entity(ies) who has made the connection, so that a reply thereto is used in preparing the encrypted information 46.

Third Embodiment

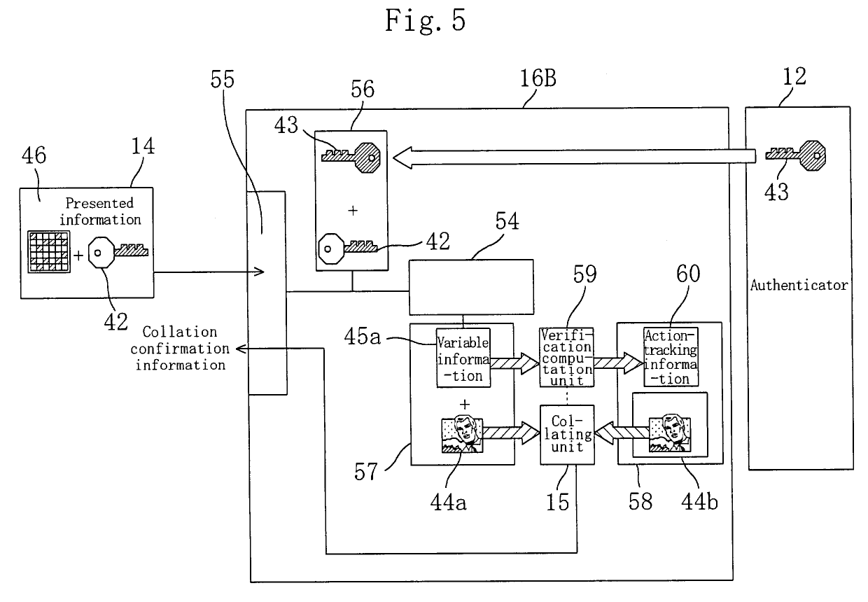

FIG. 5 is a block diagram schematically showing an example of the configuration of a verification device 16B according to a third embodiment of the present invention. As shown in FIG. 5, the verification device 16B in this embodiment includes an input/output unit 55, a first information storing unit 56, an authentication information computation unit 54, a second information storing unit 57, a verification computation unit 59, and a third information storing unit 58. The input/output unit 55 captures external signals, such as presented information 14 including encrypted information 46, and outputs signals externally. A public key 42 is stored in the first information storing unit 56. The authentication information computation unit 54 decodes information on an individual person and variable information from the presented information 14 captured from the input/output unit 55, so as to prepare authentication information. Variable information 45a and biometrics information 44a decoded from the encrypted information 46 are stored in the second information storing unit 57. The verification computation unit 59 performs calculation for verifying the decoded variable information 45a. The verified variable information as action-tracking information 60 is stored in the third information storing unit 58, and the biometrics information 44b is pre-stored in the third information storing unit 58.

In preparation to conduct authentication, an authentication requester readies, as an encryption key 41 for requesting authentication, first fixed information, which is stored separately from property, and in accordance with encryption formula readied on each such occasion, an authenticator 12 determines from the encryption key 41 an encryption key 43 for authentication. The encryption key 43 is unique to the authenticator. The public key 42, which is a common key determined by the authentication requester, and the biometrics information 44b are respectively pre-stored in the first information storing unit 56 and the third information storing unit 58 in the verification device 16B. The public key 42 and the biometrics information 44b may be stored by the authentication requester via his/her property (such as a hand-held terminal), or may be stored by the authenticator 12.

Thereafter, the authentication requester prepares the encrypted information 46 in which biometrics information 44 using biometrics such as shown in FIG. 2 and the variable information 45 on location, time, etc. are combined. The authentication requester then inputs the presented information 46, which includes the encrypted information 46 and the public key 42, into the input/output unit 55 in the verification device 16B. At the same time, an authentication requesting signal is transmitted to the authenticator 12 from the authentication requester, such that the authenticator 12 who has received the signal temporarily stores as volatile information the encryption key 43 prepared in the first information storing unit 56 in the verification device 16B during the authentication request.

Then, the authentication information computation unit 54 in the verification device 16B receives the public key 42 stored in the first information storing unit 56 and the encryption key 43 that is the volatile information captured in the first information storing unit 56, so as to decode from the encrypted information 46 the variable information 45a on location, time, etc. and the biometrics information 44b using, e.g., biometrics. The decoded information is then stored in the second information storing unit 57. The decoding operation is a computational operation that is the inverse of the computation carried out by the authentication information computation unit in the authentication request device 13A shown in FIG. 3.

The verification computation unit 59 retrieves the decoded variable information 45a on location, time, etc. from the second information storing unit 57, so as to verify whether the variable information 45a is OK or not. As the verification method, various kinds of methods are available. For example, in the case in which time and location are incorporated as the variable information 45, the present location of the authentication requester is confirmed, and if there is no confliction between the time and location as the contents of the variable information 45 and the location at which the authentication requester exists at the time of the verification, the variable information 45b can be verified as being OK. Also, in the case of a signal from a weight scale, incorporated into the variable information, if the incorporated signal does not conflict with a weight that has been pre-registered by the authentication requester, the variable information 45a can be verified as being OK.

Although the encryption key 41 is not incorporated into the encrypted information 46 in this embodiment, the encryption key 41 may be incorporated into the encrypted information 46. In that case, the combinations of the encryption key 41, the biometrics information 44 and the variable information 45 can be varied as described in the first embodiment.

When the decoded variable information 45a is verified as being OK as a result of the verification of the variable information, the verification computation unit 59 stores the decoded variable information 45a as the action-tracking information 60 in the third information storing unit 58.

Further, a collating unit 15 retrieves the decoded variable information 44a and the pre-registered biometrics information 44b from the second information storing unit 57 and the third information storing unit 58, respectively, and makes a comparison between the two so as to determine whether the biometrics information 44a and 44b coincide with each other or not. This determination can be made in a manner using conventional techniques.

As a result, collation confirmation information is output externally from the collating unit 15 and the verification computation unit 59, and the authenticator who has received the collation confirmation information replies to the authentication requester as to whether the authentication requester is authenticated or not.

The following functional effects can be exhibited by the verification device in this embodiment.

The verification device 16B uses the public keys 42 and the encryption key 43 to decode the biometrics information 44a and the variable information 45a on location, time, etc. Since the encryption key 43 is not itself the encryption key 41 for requesting authentication, abuse by a third party is prevented more reliably as compared with conventional techniques. Further, unlike the first embodiment in which the encryption key 43 is pre-stored in the verification device, the encryption key 43 in this embodiment is input as volatile information into the verification device 16B by the authenticator only when a request for authentication is made. Accordingly, the possibility of detection of the encryption key 43 by a third party from the verification device 16B is prevented more reliably as compared with the first embodiment.

Since the variable information on location, time, etc. is added into the encrypted information 46, even should a third party intercept the information sent/received between the two and attempt to gain access to the verification device 16B from another location at another time, it would be extremely difficult for the third party to be authenticated.

Furthermore, the authentication is conducted not only according to whether the biometrics information 44a and 44b coincide with each other or not, but also by considering whether the variable information 45a is reasonable or not, resulting in increase in authentication accuracy.

It should be noted that the verification computation unit 59 does not necessarily have to be provided. This is because authentication can be conducted based merely on whether the biometrics information 44a and 44b coincide with each other or not. Also, acceptability/unacceptability of the variable information 45a may be determined only when the biometrics information 44a and 44b coincide with each other, whereby time and effort necessary for the authentication can be further abbreviated with no deterioration in authentication accuracy.

It should be noted that the biometrics information 44 that is the second fixed information does not necessarily have to be used, but using it ensures that abuse of the system by a third party is more surely prevented.

Moreover, the action tracking information 60 does not necessarily have to be stored, but storing the action tracking information 60 as in this embodiment enables provision of the information as proof of the alibi of the individual person, for example, thereby increasing usability of the authentication information.

Fourth Embodiment

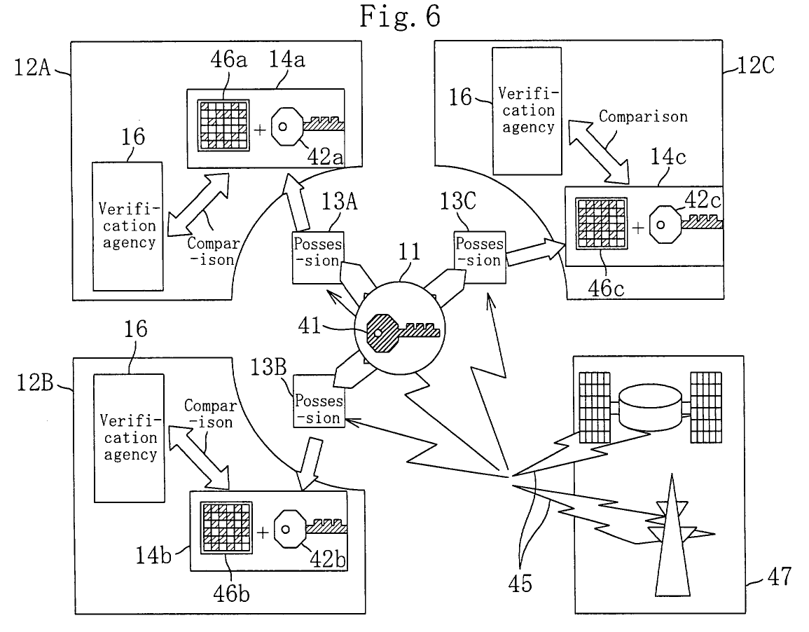

FIG. 6 is a block diagram schematically showing the configuration of an authentication system according to a fourth embodiment of the present invention. As shown in FIG. 6, a plurality of authenticators 12A, 12B and 12C are present to provide services to an authentication requester 11. The authentication requester 11 inputs an encryption key 41 into possessions 13A, 13B and 13C provided from the respective authenticators 12A, 12B and 12C, and then prepares presented information 14a, 14b and 14c, which include respective encrypted information 46a, 46b and 46c and respective public keys 42a, 42b and 42c. In each of the encrypted information 46a, 46b and 46c, variable information 45 transmitted from a variable information provider 47 and associated one of encryption keys (43a, 43b and 43c) are combined. The prepared presented information 14a, 14b and 14c are then input into the authenticators 12A, 12B and 12C, respectively. A verification agency 16 in each of the authenticators 12A, 12B and 12C conducts authentication based on the presented information 14. The operations in the property 13 of the authentication requester 11 performed at this time with respect to each of the authenticators 12A, 12B and 12C are as described in the first embodiment, except that the biometrics information 44 is not included. Note that the possessions 13A, 13B and 13C need not necessarily be physically separate hand-held terminals, for example. For instance, the possessions 13A, 13B and 13C may be incorporated into a single terminal, so long as the above-described authentication can be performed with respect to each of the authenticators 12A, 12B and 12C.

The encryption key 41 is not incorporated into the encrypted information 46 in this embodiment, buy the encryption key 41 may be incorporated into the encrypted information 46. In that case, the combinations of the encryption key 41, the biometrics information 44 and the variable information 45 may be varied as described in the first embodiment.

In the case of receiving various kinds of services, unlike a conventional system which is operated using single individual information, single property, and single encryption preparation means that are determined for each authenticator, the system in this embodiment has the advantage that the single encryption key 41, which is commonly determined for a number of authenticators, can be used.

Specifically, in the system in this embodiment, the fact that to request authentication, the authentication requester 11 only needs to remember the encryption key 41 that is the first fixed information, does not formally differ from conventional examples. Nevertheless, in the system in this embodiment, since the encryption key 41, i.e., the first fixed information in that form does not go through the system, security with respect to authentication can be increased greatly as compared with the conventional systems.

Note that in this embodiment as in the first embodiment, the authentication requester 11 may input the encryption key 41 into his/her property 13 with respect to each of the authenticators 13A, 13B and 13C, and may prepare the respective presented information 14 including the respective public keys 42a, 42b and 42c and the respective encrypted information 46a, 46b and 46c that include the combination of the second fixed information such as the biometrics information 44 shown in FIG. 2 and the variable information 45 transmitted from the variable information provider 47. In that case, the operations in the property 13 of the authentication requester 11 with respect to each of the authenticators 12A, 12B and 12C are as described in the first embodiment. Also, the operations performed at this time in the verification agency 12 in each of the authenticators 12A, 12B and 12C are as described in the first embodiment.

In addition, whether the biometrics information 44 that is the second fixed information is to be used or not may be determined on each such occasion depending on how high the level of authentication service is.

The possessions 13A, 13B and 13C of the authentication requester 11 are provided from respective service-offering companies in this embodiment. However, the property 13 itself of the authentication requester 11 may be unitary, and in such a case, programs in accordance with respective services may be stored in memories in the property 13.

The system of this embodiment which supports the above-described services provides security to both the service-providing and service-receiving ends, and is characterized in that according to the degree to which the foregoing security is guaranteed, damages in connection with security inadequacies of the system may be borne, i.e., so-called insurance services may be conducted.

Fifth Embodiment

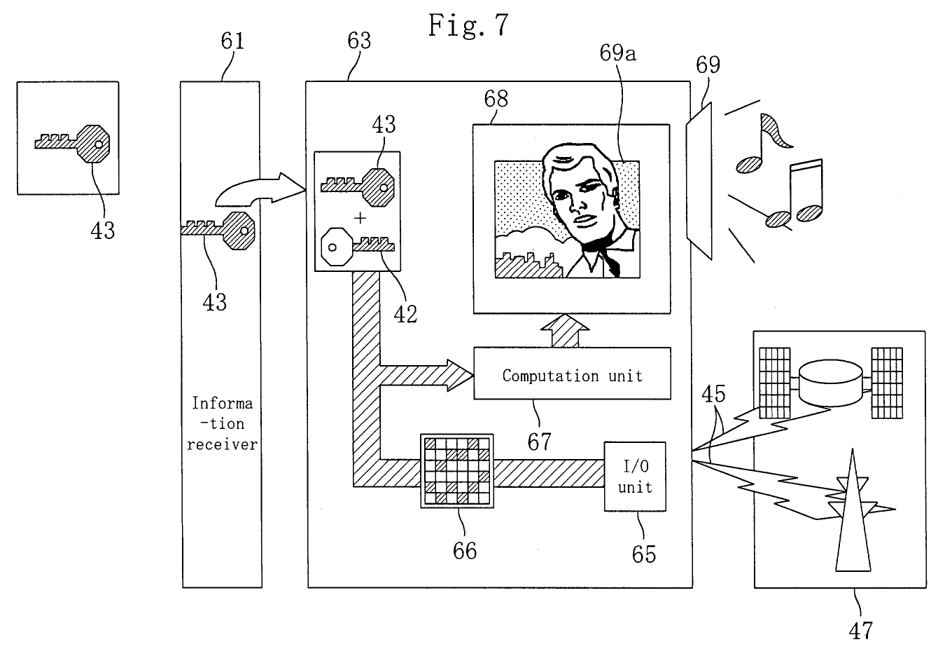

FIG. 7 is a block diagram schematically showing the configuration of an authentication system according to a fifth embodiment of the present invention. This embodiment relates to an authentication system which is obtained by slightly altering the signal flow in the first through fourth embodiments, and with which copyright can be sufficiently protected with respect to information-broadcasting service which broadcasts video or audio as information.

In the authentication system in this embodiment, an information receiver 61 purchases property 63, that is, a service medium, from an information provider (not shown). Information from the information provider, i.e., an authenticator, is encoded beforehand with an encryption key 43, i.e., first fixed information and with a public key 42, and is then added as encrypted information 66 to the property 63 that is the service medium, for sale. Specifically, the property 63 in which the encrypted information 66 and the public key 42 determined by the information provider are stored, is sold. At this time, to prepare the encrypted information 66, variable information 45 on location, time, etc. transmitted from the variable information provider 47 is captured using communication facility that is added to the property 63.

It should be noted that the public key 42 does not necessarily have to be used. Further, the biometrics information 44 that is the second fixed information does not necessarily have to be used, but using it ensures that abuse of the service medium by a third party is more surely prevented.

The encryption key 41 is not incorporated into the encrypted information 46 in this embodiment, buy the encryption key 41 may be incorporated into the encrypted information 46. In that case, the combinations of the encryption key 41, the biometrics information 44 and the variable information 45 can be varied as described in the first embodiment.

In this embodiment, in the case of decoding the distributed information from the provided encrypted information 66, the information receiver 61 may obtain an encryption key 43 separately and input the encryption key 43 to the property 63 that is the service medium, so as to perform process for decoding the information. The computation unit 67 uses the input encryption key 43 and the public key 42 that has been added to the property 63, to decode the distributed encrypted information 66, whereby the information is reproduced by reproduction units 69a and 69b through a device 68. The reproduction units 69a and 69ba may be included in the property 63, or may be separate from the property 63. In the case of image broadcasting, merely images, or images and sounds are reproduced through the device 68, and in the case in which audio is distributed, audio is reproduced through the device 68. In those cases, restrictions may be placed on the property 63, i.e., the service medium so that the encrypted information 66 can be kept in the encoded form in the property 63, thereby preventing outflow of the information in the property 63 to unspecified persons. In other words, only the information receiver 61 who has purchased the encryption key 43 together with the property that is the service medium, can enjoy the service.

In such a case, since the encryption key 43 does not remain as a default value in the service medium (property 63), outflow of the information can be prevented in the case of borrowing/lending the service medium (property 63) as well.

In the information distribution carried out in accordance with this embodiment, a charge may be made when the encrypted information 66 is broadcasted and when the encryption key 43 is broadcasted, given that the property 63 that is the service medium is purchased. In this manner, information distribution and billing are divided into two systems, such that copyright to the information can be protected and an effective information transmission can be selected. From these aspects, the information broadcasting system in this embodiment is effective in distribution business.

It should be noted that the encryption keys 41 and 43 may be biometrics information in each of the foregoing embodiments.

Industrial Applicability

The authentication system, authentication request device, verification device and service medium in the present invention are applicable to a system which is used to receive offered services or commodity products, for example, deposit-information confirmation and withdrawals from accounts at banks, commodity sales through communications lines such as on the Internet, information providing services, and distribution services.

1. An authentication system for use by an authenticator to authenticate legitimacy of an authentication requester in response to a request from the authentication requester, the authentication system comprising:
encrypted-information preparing means for receiving fixed authentication-requesting information that is unique to the authentication requester, and variable information that has characteristics varying with respect to time, so as to prepare encrypted information based on the fixed authentication-requesting information and the variable information, and
information decoding means for receiving fixed authenticating information corresponding to the fixed authentication-requesting information, and the encrypted information, so as to decode at least the fixed authentication-requesting information from the encrypted information.

2. The authentication system of claim 1, characterized by further comprising:
first fixed-information storing means for storing another fixed authentication-requesting information that is unique to the authentication requester, and
second fixed-information storing means for storing another fixed authenticating information that corresponds to said another fixed authentication-requesting information,
wherein the encrypted-information preparing means prepares the encrypted information including said another fixed authentication-requesting information as well, and
the information decoding means decodes said another fixed authentication-requesting information as well.

3. The authentication system of claim 2, characterized by further comprising collating means for receiving outputs from the information decoding means and said another fixed-information storing means, so as to compare said another fixed authentication-requesting information for agreement with said another fixed authenticating information.

4. The authentication system of claim 3, characterized in that:
the information decoding means decodes the variable information as well, and
the authentication system further includes determining means for receiving the decoded variable information to determine based on the variable information whether the authentication requester is legitimate.

5. The authentication system of any one of claims 1 through 4, characterized in that:
the encrypted-information preparing means also uses public information for encryption, so as to prepare the encrypted information, and
the information decoding means also uses public information for decryption, so as to perform the decoding.

6. The authentication system of claim 1, characterized in that:
the authenticator is a plural presence, and
the fixed authentication-requesting information is made common to each of the authenticators.

7. The authentication system of claim 1, characterized in that:
the encrypted-information preparing means and the information decoding means are incorporated into a single medium, and
the medium further includes
a circuit for generating at least one of a sound signal and an image signal, and
control means for receiving the decoded fixed authentication-requesting information to control, based on the fixed information, the circuit to be operational or non-operational.

8. An authentication system for use by an authenticator to authenticate legitimacy of an authentication requester in response to a request from the authentication requester, the authentication system comprising:
encrypted-information preparing means for receiving variable information that has characteristics varying at least with respect to time, so as to prepare encrypted information based on the variable information, and
information decoding means for receiving fixed authenticating information corresponding to fixed authentication-requesting information, and the encrypted information, so as to decode at least the variable information from the encrypted information.

9. The authentication system of claim 8, characterized by further comprising:
registered-information storing means for storing registered information for use in determining whether the variable information is appropriate or not, and
appropriateness determining means for determining whether the decoded variable information is appropriate or not, based on the registered information.

10. An authentication request device in authentication system for use by an authenticator to authenticate legitimacy of an authentication requester in response to a request from the authentication requester, the authentication request device comprising:
a variable-information input unit for receiving variable information that has characteristics varying with respect to time, and
encrypted-information preparing means for receiving the variable information from the variable-information input unit, so as to prepare encrypted information based on the variable information.

11. The authentication request device of claim 10, characterized by further comprising a fixed-information input unit for receiving fixed authentication-requesting information that is unique to the authentication requester,
wherein the encrypted-information preparing means prepares the encrypted information based on the fixed information and the variable information.

12. The authentication request device of claim 10 or 11, characterized by further comprising:
first fixed-information storing means for storing another fixed authentication-requesting information that is unique to the authentication requester, and
second fixed-information storing means for storing another fixed authenticating information corresponding to said another fixed authentication-requesting information,
wherein the encrypted-information preparing means prepares the encrypted information including said another fixed authentication-requesting information as well.

13. The authentication request device of claim 12, characterized in that said another fixed information is prepared based on image information which identifies the authentication requester.

14. The authentication request device of any one of claims 11 through 13, characterized in that the variable information is determined based on a GPS (global positioning system).

15. The authentication request device of any one of claims 11 through 13, characterized in that the variable information is determined based on information from a mobile information terminal and a mobile base station.

16. A verification device in an authentication system for use by an authenticator to authenticate legitimacy of an authentication requester in response to a request from the authentication requester, the verification device comprising:
an encrypted-information input unit for receiving encrypted information which is transmitted from the authentication requester, and which is prepared based on variable information and fixed authentication-requesting information that is unique to the authentication requester,
a fixed-information input unit for inputting fixed authenticating information corresponding to the fixed authentication-requesting information, and
information decoding means for receiving outputs from the encrypted-information input unit and the fixed-information input unit, so as to decode at least the fixed authentication-requesting information from the encrypted information.

17. The verification device of claim 16, characterized in that:
the encrypted information that is transmitted from the authentication requester includes another fixed authenticating information corresponding to the fixed authentication-requesting information, and
the verification device further includes
fixed-information storing means for storing said another fixed authenticating information corresponding to said another fixed authentication-requesting information, and
collating means for receiving outputs from the information decoding means and the fixed-information storing means, so as to compare said another fixed authentication-requesting information for agreement with the fixed authenticating information.

18. The verification device of claim 16 or 17, characterized in that
the information decoding means decodes the variable information as well, and
the verification device further includes determining means for receiving the decoded variable information to determine legitimacy of the authentication requester based on the variable information.

19. A verification device in an authentication system for use by an authenticator to authenticate legitimacy of an authentication requester in response to a request from the authentication requester, the verification device comprising:
an encrypted-information input unit for receiving encrypted information prepared based on variable information transmitted from the authentication requester, and
information decoding means for receiving an output from the encrypted-information input unit, so as to decode at least the variable information from the encrypted information.

20. The verification device of claim 19, characterized by further comprising
registered-information storing means for storing registered information for use in determining whether the variable information is appropriate or not, and
appropriateness determining means for determining whether the decoded variable information is appropriate or not, based on the registered information.

21. A service medium in an authentication system for use by an authenticator to authenticate legitimacy of an authentication requester in response to a request from the authentication requester, the service medium comprising:
a fixed-information input unit for receiving fixed authentication-requesting information that is unique to the authentication requester,
a variable-information input unit for receiving variable information that has characteristics varying with respect to time,
encrypted-information preparing means for receiving the fixed authentication-requesting information and the variable information, so as to prepare encrypted information based on the fixed authentication-requesting information and the variable information,
information decoding means for receiving fixed authenticating information corresponding to the fixed authentication-requesting information, and an output from the encrypted-information preparing means, so as to decode at least the fixed authentication-requesting information from the encrypted information,
a circuit for generating at least one of a sound signal and an image signal, and
control means for receiving the decoded fixed authentication-requesting information to control, based on the fixed information, the circuit to be operational or non-operational.

22. A service medium in an authentication system for use by an authenticator to authenticate legitimacy of an authentication requester in response to a request from the authentication requester, the service medium comprising:
a variable-information input unit for receiving variable information that has characteristics varying with respect to time,
encrypted-information preparing means for preparing encrypted information based on the variable information,
information decoding means for receiving an output from the encrypted-information preparing means, so as to decode at least the variable information from the encrypted information,
a circuit for generating at least one of a sound signal and an image signal, and
control means for receiving the decoded variable information to control, based on the variable information, the circuit to be operational or non-operational.
